(19) United States
(12) Patent Application Publication
(10) Pub. No.: US 2014/0355804 A1
(43) Pub. Date: Dec. 4, 2014

(54) INCREASING ANTENNA PERFORMANCE FOR WIRELESS HEARING ASSISTANCE DEVICES

(71) Applicant: STARKEY LABORATORIES, INC., EDEN PRAIRIE, MN (US)

(72) Inventors: Jay Rabel, Shorewood, MN (US); Jorge F. Sanguino, Hopkins, MN (US)

(73) Assignee: STARKEY LABORATORIES, INC., EDEN PRAIRIE, MN (US)

(21) Appl. No.: 14/267,708

(22) Filed: May 1, 2014

Related U.S. Application Data
(60) Provisional application No. 61/818,371, filed on May 1, 2013.

(51) Int. Cl. H04R 25/00; H01Q 1/27; H01Q 1/52

(52) U.S. Cl. CPC H04R 25/554; H01Q 1/52; H01Q 1/273; H04R 25/652; H04R 2460/17
USPC 381/328

(57) ABSTRACT

Disclosed herein, among other things, are methods and apparatus for increasing antenna performance for hearing assistance devices. One aspect of the present subject matter includes a receiver-in-canal (RIC) hearing assistance device for a wearer including an antenna within a device housing, an audio receiver configured to be worn in an ear canal of a wearer, and a cable assembly configured to connect the audio receiver to the device housing. A ferrite element or an inductor is connected to the cable assembly and configured to reduce unwanted coupling between the cable assembly and the antenna by reducing high frequency current through the wires of the cable assembly. According to various embodiments, the ferrite element or the inductor is connected in series to the cable assembly adjacent to the device housing.

### CLAIM OF PRIORITY AND INCORPORATION BY REFERENCE

The present application claims the benefit under 35 U.S.C. §119(e) of U.S. Provisional Patent Application 61/818,371, filed May 1, 2013, the disclosure of which is hereby incorporated by reference herein in its entirety.

### TECHNICAL FIELD

This document relates generally to hearing assistance systems and more particularly to methods and apparatus for increasing antenna performance for wireless hearing assistance devices.

### BACKGROUND

Modern hearing assistance devices, such as hearing aids, are electronic instruments worn in or around the ear that compensate for hearing losses by specially amplifying sound. Some hearing aids include an antenna for radio frequency (RF) communications. Antenna performance can be affected by coupling of the antenna system with conductors of an audio receiver, which creates a flow of high frequency current through the audio receiver wires, causing the wires to become an RF radiator. This unwanted coupling between the antenna and the audio receiver cables can cause a variance in RF gain which can create wireless link performance problems.

Accordingly, there is a need in the art for improved systems and methods for increasing antenna performance for hearing assistance devices.

### SUMMARY

Disclosed herein, among other things, are methods and apparatus for increasing antenna performance for hearing assistance devices. One aspect of the present subject matter includes a receiver-in-canal (RIC) hearing assistance device for a wearer including an antenna within a device housing, an audio receiver configured to be worn in an ear canal of a wearer, and a cable assembly configured to connect the audio receiver to the device housing. A ferrite element, such as a ferrite bead for example, or an inductor is connected to the cable assembly and configured to reduce unwanted coupling between the cable assembly and the antenna by reducing high frequency current through the wires of the cable assembly. According to various embodiments, the ferrite element or the inductor is connected in series to the cable assembly adjacent to the device housing and/or adjacent to the audio receiver.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a cross-sectional view of a receiver-in-the-canal (RIC) hearing assistance device, according to various embodiments of the present subject matter.

FIG. 2 illustrates a portion of a receiver cable for connecting to a device housing, according to various embodiments of the present subject matter.

FIG. 3 illustrates a portion of a receiver cable for connecting to a receiver assembly, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Some hearing aids include an antenna for radio frequency (RF) communications. Antenna performance can be affected by coupling of the antenna system with conductors of an audio receiver, which creates a flow of high frequency current through the audio receiver wires, causing the wires to become an RF radiator and causing transmission to be much different that reception for the antenna. For certain wire lengths (based on cable assembly length) and impedances (based on receiver type), the wires will become the primary radiator with higher radiation efficiency than the intended hearing aid antenna. The variance in RF gain can create wireless link performance problems. If the antenna gain is increased, the hearing aid RF receiver will be exposed to higher levels of undesirable signals that will degrade its sensitivity performance in some environments (examples: near a cell phone hub, tower or repeater). The hearing aid RF transmit power variation may be too high to meet regulatory requirements.

Disclosed herein, among other things, are methods and apparatus for increasing antenna performance for hearing assistance devices. One aspect of the present subject matter includes a receiver-in-canal (RIC) hearing assistance device for a wearer including an antenna within a device housing, an audio receiver configured to be worn in an ear canal of a wearer, and a cable assembly configured to connect the audio receiver to the device housing. A ferrite bead or an inductor is connected to the cable assembly and configured to reduce unwanted coupling between the cable assembly and the antenna by reducing high frequency current through the wires of the cable assembly. According to various embodiments, the ferrite bead or the inductor is connected in series to the cable assembly adjacent to the device housing. Thus, ferrite beads or inductors can be used to reduce the flow of current through the audio receiver wires. The location of the ferrite beads or inductors can be adjusted to reduce the flow of current.

The present subject matter improves wireless RIC hearing aids antenna performance. In addition, the present subject matter improves antenna system gain consistency with different length cables and different types of receivers, and when worn by different users. Thus, the present subject matter can be used to manage transmit and receive performance of the antenna system. One prior solution to this problem was to use ferrites on the flex substrate that are located inside the antenna aperture. However, locating ferrites inside the antenna aperture provides less control of the induced current. This yields poorer improvement of gain consistency and less gain control. The present subject matter locates the ferrites or inductors outside the antenna aperture.

The present subject matter uses the audio wireless receiver, connecting cables, inductors and ferrites to adjust induced RF current flow on the receiver/cable assemblies to control hearing aid antenna system gain and make antenna performance more consistent (less uncontrolled) with different length cables and/ different types of receivers. This will also improve consistency when worn by different hearing aid wearers. Thus, the present subject matter employs the use and control of induced RF current flow on the receiver/cable assemblies to control hearing aid antenna system gain.

During hearing aid operation, current is induced on RIC cable/receiver assemblies that affects the wireless HA antenna system gain and gain sensitivity to different length cables, different types of receivers, and human tissue proximity. In various embodiments, the present subject matter provides series ferrites or inductors that are inserted in the receiver cable lines to reduce or control induced RF current flow on the receiver/cable assemblies to control hearing aid system gain and make antenna performance more consistent (less un-controlled) across users. When the device housing is directly coupled to the receiver cables, greater gain variation due to receiver/cable to tissue proximity, tissue density, etc. will be seen. In one embodiment, to increase control or minimize RF current flow on the cable assembly, the ferrite or inductor is located outside of the antenna aperture. The use of inductors or properly selected ferrites reduces hearing aid system antenna gain and gain sensitivity to different length cables and different types of receivers.

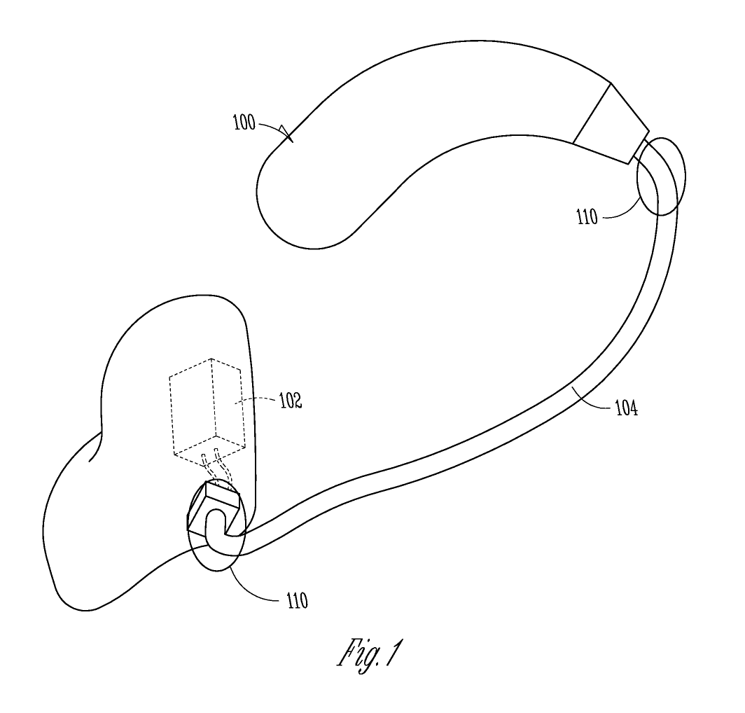

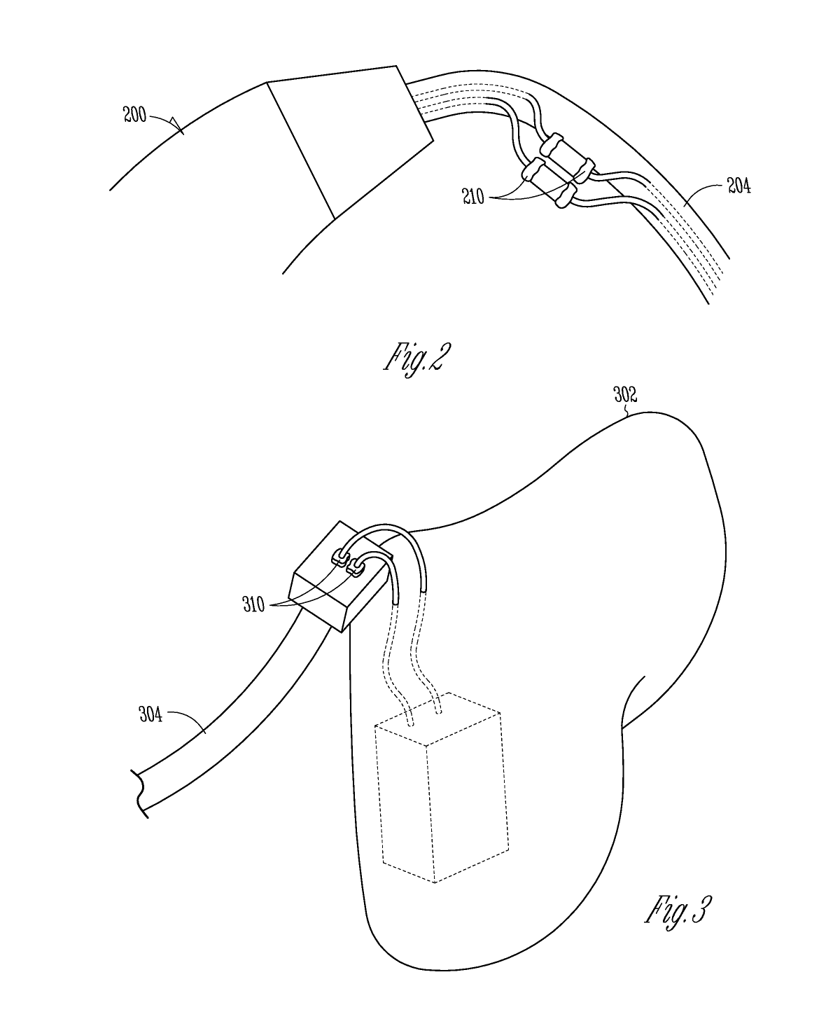

FIG. 1 illustrates a cross-sectional view of a receiver-in-the-canal (RIC) hearing assistance device, according to various embodiments of the present subject matter. The RIC device includes an antenna within a device housing 100, an audio receiver 102 configured to be worn in an ear canal of a wearer, and a cable assembly 104 configured to connect the audio receiver 102 to the device housing 100. A ferrite bead or an inductor 110 is connected to the cable assembly (as shown in FIGS. 2 and 3) and configured to reduce unwanted coupling between the cable assembly and the antenna by reducing high frequency current through the wires of the cable assembly. The antenna can have a variety of configurations, including an antenna having an aperture, in various embodiments.

FIG. 2 illustrates a portion of a receiver cable 204 for connecting to a device housing 200, according to various embodiments of the present subject matter. In various embodiments, ferrites (such as ferrite beads) or inductors 210 are connected in series in the receiver cable lines to reduce or control induced RF current flow on the receiver/cable assemblies to control gain and make antenna performance more consistent for a variety of wearers. In the depicted embodiment, the ferrites or inductors 210 are connected directly adjacent to the device housing 200, thus close to but outside of the aperture of the antenna.

FIG. 3 illustrates a portion of a receiver cable 304 for connecting to a receiver assembly 302, according to various embodiments of the present subject matter. In various embodiments, ferrites (such as ferrite beads) or inductors 310 are connected in series in the receiver cable lines to reduce or control induced RF current flow on the receiver/cable assemblies to control gain and make antenna performance more consistent for a variety of wearers. In the depicted embodiment, the ferrites or inductors 310 are connected directly adjacent to the receiver assembly 302.

In various embodiments, using a ferrite bead or inductor that has impedance higher than 550 ohms at 900 MHz reduces transmit and receive variance from 11 dB to less than 1 dB, a more than 10 dB improvement. In one embodiment, two ferrite beads are used to open the flow of current to the audio receiver wires. In various embodiments, the ferrite bead or inductor is located as close as possible to the silicon connector used to connect the cable assembly to the receiver or the device housing. In various embodiments, a ferrite bead or inductor is placed at each end of the cable assembly (as shown in FIG. 1).

According to various embodiments, other components such as capacitors (instead of or in addition to ferrites or inductors) could be used to control antenna gain. In further embodiments, combinations of components can be used. In still further embodiments, components such as ferrite beads or inductors are mounted on a printed circuit board (PCB), mounted in the hearing aid assembly housing but outside of the hearing aid antenna aperture, mounted in the cable, and/or mounted in the receiver assembly. In various embodiments, a component such as a ferrite bead or inductor is connected in series to other assemblies outside of the hearing aid antenna aperture to control current induced on cables and various hearing aid electronics or components (i.e. external microphones, an external giant magnetoresistive (GMR) sensor, a head sensor, etc.). In various embodiments, cable and/or receiver assemblies are manufactured to include the inductors or ferrites. The present subject matter improves performance management of the antenna system, in various embodiments.

Various embodiments of the present subject matter support wireless communications with a hearing assistance device. In various embodiments the wireless communications can include standard or nonstandard communications. Some examples of standard wireless communications include link protocols including, but not limited to, Bluetooth™, IEEE 802.11 (wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications. Although the present system is demonstrated as a radio system, it is possible that other forms of wireless communications can be used such as ultrasonic, optical, infrared, and others. It is understood that the standards which can be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

It is understood that variations in communications protocols, antenna configurations, and combinations of components may be employed without departing from the scope of the present subject matter. Hearing assistance devices typically include an enclosure or housing, a microphone, hearing assistance device electronics including processing electronics, and a speaker or receiver. It is understood that in various embodiments the microphone is optional. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the wearer.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, audio decoding, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A receiver-in-canal (RIC) hearing assistance device for a wearer, comprising:
a device housing;
an antenna within the device housing;
an audio receiver configured to be worn in an ear canal of a wearer;
a cable assembly configured to connect the audio receiver to the device housing; and
a ferrite element or an inductor connected to the cable assembly and configured to reduce unwanted coupling between the cable assembly and the antenna by reducing high frequency current through wires of the cable assembly.

2. The device of claim 1, wherein the ferrite element or the inductor is connected in series with the cable assembly.

3. The device of claim 1, wherein the ferrite element or the inductor is connected to the cable assembly adjacent to the device housing.

4. The device of claim 1, wherein the ferrite element or the inductor is located adjacent the device housing outside of an antenna aperture.

5. The device of claim 1, wherein the ferrite element or the inductor is located inside the device housing.

6. The device of claim 1, wherein the ferrite element or the inductor is located adjacent the audio receiver.

7. The device of claim 1, wherein the ferrite element or the inductor is configured to be used to adjust induced RF current flow on the cable assembly.

8. The device of claim 7, wherein the ferrite element or the inductor is configured to be used to adjust induced RF current flow for different cable assembly lengths.

9. The device of claim 7, wherein the ferrite element or the inductor is configured to be used to adjust induced RF current flow for different receiver types.

10. The device of claim 7, wherein the ferrite element or the inductor is configured to be used to adjust induced RF current flow for different wearers of the device.

11. The device of claim 7, wherein the ferrite element or the inductor is configured to be used to adjust induced RF current flow based on tissue proximity of the wearer.

12. The device of claim 7, wherein the ferrite element or the inductor is configured to be used to adjust induced RF current flow based on tissue density of the wearer.

13. The device of claim 1, wherein the ferrite element or the inductor includes an impedance greater than 550 ohms at 900 MHz.

14. The device of claim 1, comprising multiple ferrite elements or inductors connected to the cable assembly.

15. The device of claim 14, wherein a ferrite element or inductor is positioned at each end of the cable assembly

16. The device of claim 1, further comprising a capacitor connected to the cable assembly and configured to control antenna gain.

17. The device of claim 1, wherein the ferrite element or the inductor is mounted in the device housing but outside an antenna aperture.

18. The device of claim 1, wherein the ferrite element or the inductor is mounted on a printed circuit board (PCB).

19. The device of claim 1, wherein the ferrite element or the inductor is mounted in the cable assembly.

20. The device of claim 1, wherein the ferrite element or the inductor is mounted in a receiver assembly housing the audio receiver.

21. The device of claim 1, wherein a ferrite element or inductor is connected in series to other assemblies outside of the housing to control current induced on cables and hearing aid electronics or components.

22. A method, comprising:
connecting a ferrite element or an inductor to a cable assembly configured to connect an audio receiver configured to be worn in an ear canal to a hearing assistance device housing, the ferrite element or the inductor configured to reduce unwanted coupling between the cable assembly and an antenna of the hearing assistance device by reducing high frequency current through wires of the cable assembly.

23. The method of claim 22, wherein connecting the ferrite element or the inductor includes connecting the ferrite element or the inductor in series to the cable assembly adjacent the housing.

24. The method of claim 22, wherein connecting the ferrite element or the inductor includes connecting the ferrite element or the inductor adjacent a receiver assembly housing the audio receiver.
